(19) United States
(12) Patent Application Publication
(10) Pub. No.: US 2023/0334385 A1
(43) Pub. Date: Oct. 19, 2023

(54) SYSTEMS AND METHODS FOR PRIORITIZING TASKS

(71) Applicant: Citrix Systems, Inc., Fort Lauderdale, FL (US)

(72) Inventors: Jia Yin, Nanjing (CN); Hailong Li, Nanjing (CN); Shuai Ye, Nanjing (CN); Chuchu Ye, Nanjing (CN)

(21) Appl. No.: 17/664,051

(22) Filed: May 19, 2022

Related U.S. Application Data
(63) Continuation of application No. PCT/CN2022/086623, filed on Apr. 13, 2022.

(51) Int. Cl. G06Q 10/10; G06Q 10/06

(52) U.S. Cl. CPC G06Q 10/06311; G06Q 10/1097

(57) ABSTRACT

In one aspect, an example methodology implementing the disclosed techniques can include, by a first computing device, determining two or more of tasks associated with a user and determining, a priority of each task of the two or more tasks based on a deadline and an importance of the task. The method can also include, by the first computing device, determining dependencies between different ones of the two or more tasks and sorting the two or more tasks based on the priority of each task of the two or more tasks and the determined dependencies. The method can also include, by the first computing device, causing at least a portion of the sorted two or more tasks to be displayed in a user interface (UI) of an application on a second computing device.

### CROSS REFERENCE TO RELATED APPLICATIONS

This application is a continuation of and claims the benefit of PCT Pat. Application No. PCT/CN2022/086623 filed on Apr. 13, 2022 in the English language in the State Intellectual Property Office and designating the United States, the contents of which are hereby incorporated herein by reference in its entirety.

### BACKGROUND

Organizations, such as companies, enterprises, and firms, work on many projects at the same time. A typical project may involve a large number of tasks which need to be assigned and performed for the successful completion of the project. For example, a user within an organization may use a project management tool to create and assign tasks (or “tickets”) to different users within the organization. Some tasks may have a deadline, meaning a date or time by which the task is expected to be completed. These tasks may also have a business value, meaning an importance of the task to the overall success of the project. In some cases, a task’s business value may be specified by the user assigning the task.

It is not uncommon for a user within an organization to be assigned numerous tasks which need to be completed in a given period of time, such as two weeks, four weeks, six weeks, etc. While traditional project management tools provide features for management of assigned tasks, they do not help with prioritizing the tasks for successful completion by the assigned user. As a result, in many instances, the user is left to decide the order in which the assigned tasks should be performed.

### SUMMARY

This Summary is provided to introduce a selection of concepts in simplified form that are further described below in the Detailed Description. This Summary is not intended to identify key or essential features or combinations of the claimed subject matter, nor is it intended to be used to limit the scope of the claimed subject matter.

A user needs to prioritize his or her assigned tasks in order to perform the assigned tasks by their stated deadlines. To effectively prioritize assigned tasks, the user needs to assess and quantify factors such as deadlines, business values, and dependencies of the assigned tasks. Although some of this information may be provided with the assigned tasks, prioritizing the assigned tasks can be difficult and time consuming for the user due to the user’s lack of comprehensive understanding of the relationships between such factors. As a result, the user may find it challenging to perform the assigned tasks by their stated deadlines. For example, in the case of hardware, software and/or similar development projects, relying on users (e.g., engineers and/or programmers) to decide the task order can increase the time to complete the project, thereby increasing processor usage (e.g., editing and compiling code) and usage of other computational resources. The challenge is compounded in cases where a large number of tasks are assigned to the user.

In accordance with one example embodiment provided to illustrate the broader concepts, systems, and techniques described herein, a method includes, by a first computing device, determining a plurality of tasks associated with a user and determining a priority of each task of the plurality of tasks based on a deadline and an importance of the task. The method also includes, by the first computing device, determining dependencies between different ones of the plurality of tasks and sorting the plurality of tasks based on the priority of each task of the plurality of tasks and the determined dependencies. The method also includes, by the first computing device, causing at least a portion of the sorted plurality of tasks to be displayed in a user interface (UI) of an application on a second computing device.

In some embodiments, determining the priority of a task includes calculating a weighted sum of the deadline and the importance of the task. In some embodiments, for ones of the plurality of tasks, the deadline of the task is a normalized deadline calculated based on a number of working days in a predetermined time period, a deadline date of the task, and a current date. In some embodiments, for ones of the plurality of tasks, the importance of the task is a normalized importance calculated based on an actual importance of the task and a highest importance of the plurality of tasks.

In some embodiments, the method further includes determining, by the first computing device, a first task of the plurality of tasks being dependent on a task associated with another user, wherein sorting of the plurality of tasks includes placing the first task at the end of the plurality of tasks based on the determination that the first task is dependent the task associated with the another user. In some embodiments, the method further includes grouping, by the first computing device, a second task and a third task of the plurality of tasks in a task block, the second task being dependent on the third task, wherein sorting of the plurality of tasks includes placing the task block in the sorted plurality of tasks in accordance with an average of the priorities of the second task and the third task. In one aspect, sorting the plurality of tasks includes placing the task block in the sorted plurality of tasks in accordance with a number of tasks included in the task block. In some embodiments, the method also includes sorting, by the first computing device, the second task and the third task within the task block based on dependency of the second task and the third task.

According to another illustrative embodiment provided to illustrate the broader concepts described herein, a system includes a processor and a non-volatile memory storing computer program code that when executed on the processor, causes the processor to execute a process corresponding to the aforementioned method or any described embodiment thereof.

According to another illustrative embodiment provided to illustrate the broader concepts described herein, a non-transitory machine-readable medium encodes instructions that when executed by one or more processors cause a process to be carried out, the process corresponding to the aforementioned method or any described embodiment thereof.

### BRIEF DESCRIPTION OF THE DRAWINGS

The foregoing and other objects, features and advantages will be apparent from the following more particular description of the embodiments, as illustrated in the accompanying drawings in which like reference characters refer to the same parts throughout the different views. The drawings are not necessarily to scale, emphasis instead being placed upon illustrating the principles of the embodiments.

FIG. 1 is a diagram of an illustrative network computing environment in which embodiments of the present disclosure may be implemented.

FIG. 2 is a block diagram illustrating selective components of an example computing device in which various aspects of the disclosure may be implemented, in accordance with an embodiment of the present disclosure.

FIG. 3 is a schematic block diagram of a cloud computing environment in which various aspects of the disclosure may be implemented.

FIG. 4A is a block diagram of an illustrative system in which resource management services may manage and streamline access by clients to resource feeds (via one or more gateway services) and/or software-as-a-service (SaaS) applications.

FIG. 4B is a block diagram showing an illustrative implementation of the system shown in FIG. 4A in which various resource management services as well as a gateway service are located within a cloud computing environment.

FIG. 4C is a block diagram similar to FIG. 4B but in which the available resources are represented by a single box labeled “systems of record,” and further in which several different services are included among the resource management services.

FIG. 5 is a block diagram of an illustrative system for automatically prioritizing tasks, in accordance with an embodiment of the present disclosure.

FIG. 6 is a diagram of an illustrative user interface (UI) for presenting prioritized tasks, in accordance with an embodiment of the present disclosure.

FIG. 7 is a flow diagram illustrating an illustrative process for prioritizing tasks, in accordance with an embodiment of the present disclosure.

FIG. 8 is a diagram illustrating a prioritization of tasks, in accordance with an embodiment of the present disclosure.

### DETAILED DESCRIPTION

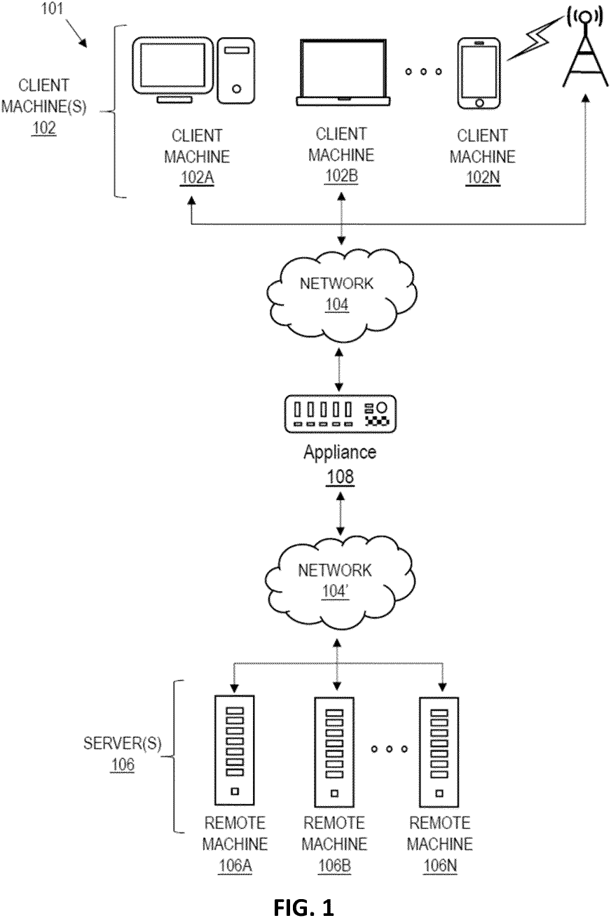

Referring now to FIG. 1, shown is an illustrative network environment 101 of computing devices in which various aspects of the disclosure may be implemented, in accordance with an embodiment of the present disclosure. As shown, environment 101 includes one or more client machines 102A-102N, one or more remote machines 106A-106N, one or more networks 104, 104′, and one or more appliances 108 installed within environment 101. Client machines 102A-102N communicate with remote machines 106A-106N via networks 104, 104′.

In some embodiments, client machines 102A-102N communicate with remote machines 106A-106N via an intermediary appliance 108. The illustrated appliance 108 is positioned between networks 104, 104′ and may also be referred to as a network interface or gateway. In some embodiments, appliance 108 may operate as an application delivery controller (ADC) to provide clients with access to business applications and other data deployed in a datacenter, a cloud computing environment, or delivered as Software as a Service (SaaS) across a range of client devices, and/or provide other functionality such as load balancing, etc. In some embodiments, multiple appliances 108 may be used, and appliance(s) 108 may be deployed as part of network 104 and/or 104′.

Client machines 102A-102N may be generally referred to as client machines 102, local machines 102, clients 102, client nodes 102, client computers 102, client devices 102, computing devices 102, endpoints 102, or endpoint nodes 102. Remote machines 106A-106N may be generally referred to as servers 106 or a server farm 106. In some embodiments, a client device 102 may have the capacity to function as both a client node seeking access to resources provided by server 106 and as a server 106 providing access to hosted resources for other client devices 102A-102N. Networks 104, 104′ may be generally referred to as a network 104. Networks 104 may be configured in any combination of wired and wireless networks.

Server 106 may be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

Server 106 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions.

In some embodiments, server 106 may execute a remote presentation services program or other program that uses a thin-client or a remote-display protocol to capture display output generated by an application executing on server 106 and transmit the application display output to client device 102.

In yet other embodiments, server 106 may execute a virtual machine providing, to a user of client device 102, access to a computing environment. Client device 102 may be a virtual machine. The virtual machine may be managed by, for example, a hypervisor, a virtual machine manager (VMM), or any other hardware virtualization technique within server 106.

In some embodiments, network 104 may be: a local-area network (LAN); a metropolitan area network (MAN); a wide area network (WAN); a primary public network; and a primary private network. Additional embodiments may include a network 104 of mobile telephone networks that use various protocols to communicate among mobile devices. For short range communications within a wireless local-area network (WLAN), the protocols may include 802.11, Bluetooth, and Near Field Communication (NFC).

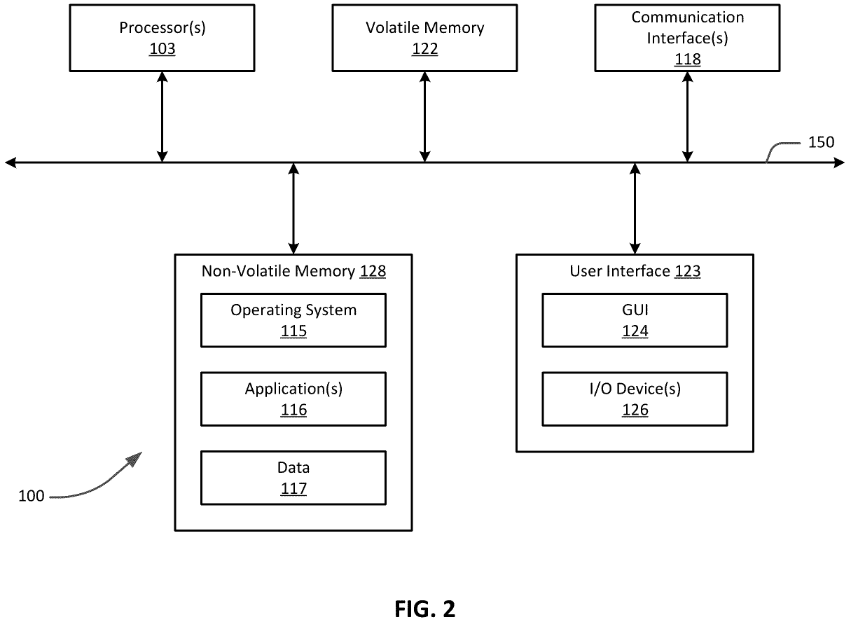

FIG. 2 is a block diagram illustrating selective components of an illustrative computing device 100 in which various aspects of the disclosure may be implemented, in accordance with an embodiment of the present disclosure. For instance, client devices 102, appliances 108, and/or servers 106 of FIG. 1 can be substantially similar to computing device 100. As shown, computing device 100 includes one or more processors 103, a volatile memory 122 (e.g., random access memory (RAM)), a non-volatile memory 128, a user interface (UI) 123, one or more communications interfaces 118, and a communications bus 150.

Non-volatile memory 128 may include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

User interface 123 may include a graphical user interface (GUI) 124 (e.g., a touchscreen, a display, etc.) and one or more input/output (I/O) devices 126 (e.g., a mouse, a keyboard, a microphone, one or more speakers, one or more cameras, one or more biometric scanners, one or more environmental sensors, and one or more accelerometers, etc.).

Non-volatile memory 128 stores an operating system 115, one or more applications 116, and data 117 such that, for example, computer instructions of operating system 115 and/or applications 116 are executed by processor(s) 103 out of volatile memory 122. In some embodiments, volatile memory 122 may include one or more types of RAM and/or a cache memory that may offer a faster response time than a main memory. Data may be entered using an input device of GUI 124 or received from I/O device(s) 126. Various elements of computing device 100 may communicate via communications bus 150.

The illustrated computing device 100 is shown merely as an illustrative client device or server and may be implemented by any computing or processing environment with any type of machine or set of machines that may have suitable hardware and/or software capable of operating as described herein.

Processor(s) 103 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A processor may perform the function, operation, or sequence of operations using digital values and/or using analog signals.

In some embodiments, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory.

Processor 103 may be analog, digital or mixed signal. In some embodiments, processor 103 may be one or more physical processors, or one or more virtual (e.g., remotely located or cloud computing environment) processors. A processor including multiple processor cores and/or multiple processors may provide functionality for parallel, simultaneous execution of instructions or for parallel, simultaneous execution of one instruction on more than one piece of data.

Communications interfaces 118 may include one or more interfaces to enable computing device 100 to access a computer network such as a Local Area Network (LAN), a Wide Area Network (WAN), a Personal Area Network (PAN), or the Internet through a variety of wired and/or wireless connections, including cellular connections.

In described embodiments, computing device 100 may execute an application on behalf of a user of a client device. For example, computing device 100 may execute one or more virtual machines managed by a hypervisor. Each virtual machine may provide an execution session within which applications execute on behalf of a user or a client device, such as a hosted desktop session. Computing device 100 may also execute a terminal services session to provide a hosted desktop environment. Computing device 100 may provide access to a remote computing environment including one or more applications, one or more desktop applications, and one or more desktop sessions in which one or more applications may execute.

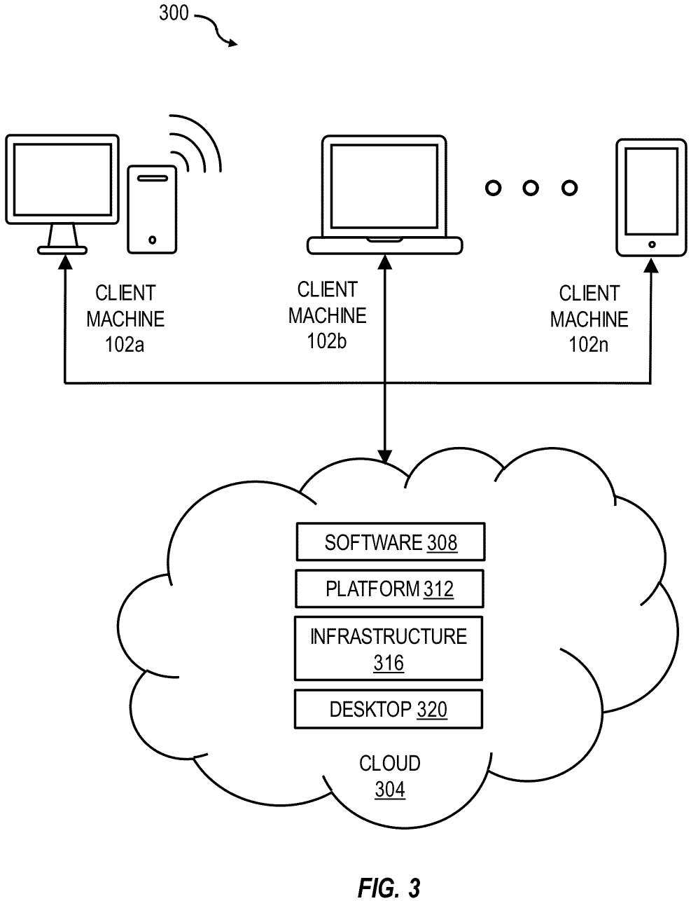

Referring to FIG. 3, a cloud computing environment 300 is depicted, which may also be referred to as a cloud environment, cloud computing or cloud network. Cloud computing environment 300 can provide the delivery of shared computing services and/or resources to multiple users or tenants. For example, the shared resources and services can include, but are not limited to, networks, network bandwidth, servers, processing, memory, storage, applications, virtual machines, databases, software, hardware, analytics, and intelligence.

In cloud computing environment 300, one or more clients 102a-102n (such as those described above) are in communication with a cloud network 304. Cloud network 304 may include back-end platforms, e.g., servers, storage, server farms or data centers. The users or clients 102a-102n can correspond to a single organization/tenant or multiple organizations/tenants. More particularly, in one illustrative implementation, cloud computing environment 300 may provide a private cloud serving a single organization (e.g., enterprise cloud). In another example, cloud computing environment 300 may provide a community or public cloud serving multiple organizations/tenants.

In some embodiments, a gateway appliance(s) or service may be utilized to provide access to cloud computing resources and virtual sessions. By way of example, Citrix Gateway, provided by Citrix Systems, Inc., may be deployed on-premises or on public clouds to provide users with secure access and single sign-on to virtual, SaaS and web applications. Furthermore, to protect users from web threats, a gateway such as Citrix Secure Web Gateway may be used. Citrix Secure Web Gateway uses a cloud-based service and a local cache to check for URL reputation and category.

In still further embodiments, cloud computing environment 300 may provide a hybrid cloud that is a combination of a public cloud and a private cloud. Public clouds may include public servers that are maintained by third parties to clients 102a-102n or the enterprise/tenant. The servers may be located off-site in remote geographical locations or otherwise.

Cloud computing environment 300 can provide resource pooling to serve multiple users via clients 102a-102n through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In some embodiments, cloud computing environment 300 can provide on-demand self-service to unilaterally provision computing capabilities (e.g., server time, network storage) across a network for multiple clients 102a-102n. By way of example, provisioning services may be provided through a system such as Citrix Provisioning Services (Citrix PVS). Citrix PVS is a software-streaming technology that delivers patches, updates, and other configuration information to multiple virtual desktop endpoints through a shared desktop image. Cloud computing environment 300 can provide an elasticity to dynamically scale out or scale in response to different demands from one or more clients 102. In some embodiments, cloud computing environment 300 can include or provide monitoring services to monitor, control and/or generate reports corresponding to the provided shared services and resources.

In some embodiments, cloud computing environment 300 may provide cloud-based delivery of different types of cloud computing services, such as Software as a service (SaaS) 308, Platform as a Service (PaaS) 312, Infrastructure as a Service (IaaS) 316, and Desktop as a Service (DaaS) 320, for example. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Washington, RACKSPACE CLOUD provided by Rackspace US, Inc., of San Antonio, Texas, Google Compute Engine provided by Google Inc. of Mountain View, California, or RIGHTSCALE provided by RightScale, Inc., of Santa Barbara, California.

PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Washington, Google App Engine provided by Google Inc., and HEROKU provided by Heroku, Inc. of San Francisco, California.

SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, California, or OFFICE 365 provided by Microsoft Corporation. Examples of SaaS may also include data storage providers, e.g., Citrix ShareFile from Citrix Systems, DROPBOX provided by Dropbox, Inc. of San Francisco, California, Microsoft SKYDRIVE provided by Microsoft Corporation, Google Drive provided by Google Inc., or Apple ICLOUD provided by Apple Inc. of Cupertino, California.

Similar to SaaS, DaaS (which is also known as hosted desktop services) is a form of virtual desktop infrastructure (VDI) in which virtual desktop sessions are typically delivered as a cloud service along with the apps used on the virtual desktop. Citrix Cloud from Citrix Systems is one example of a DaaS delivery platform. DaaS delivery platforms may be hosted on a public cloud computing infrastructure such as AZURE CLOUD from Microsoft Corporation of Redmond, Washington (herein “Azure”), or AMAZON WEB SERVICES provided by Amazon.com, Inc., of Seattle, Washington (herein “AWS”), for example. In the case of Citrix Cloud, Citrix Workspace app may be used as a single-entry point for bringing apps, files and desktops together (whether on-premises or in the cloud) to deliver a unified experience.

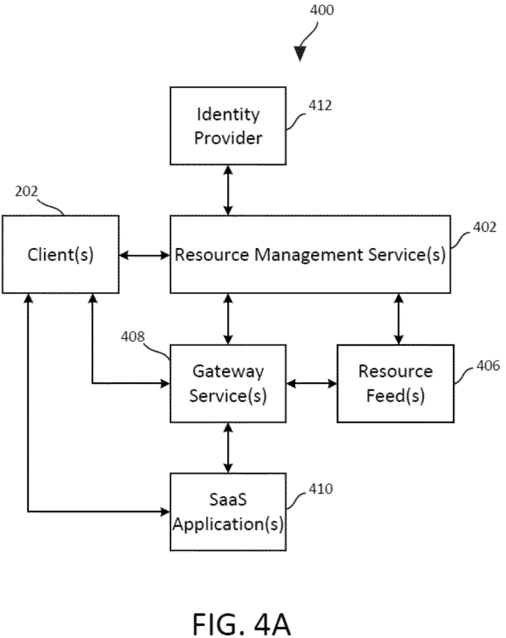

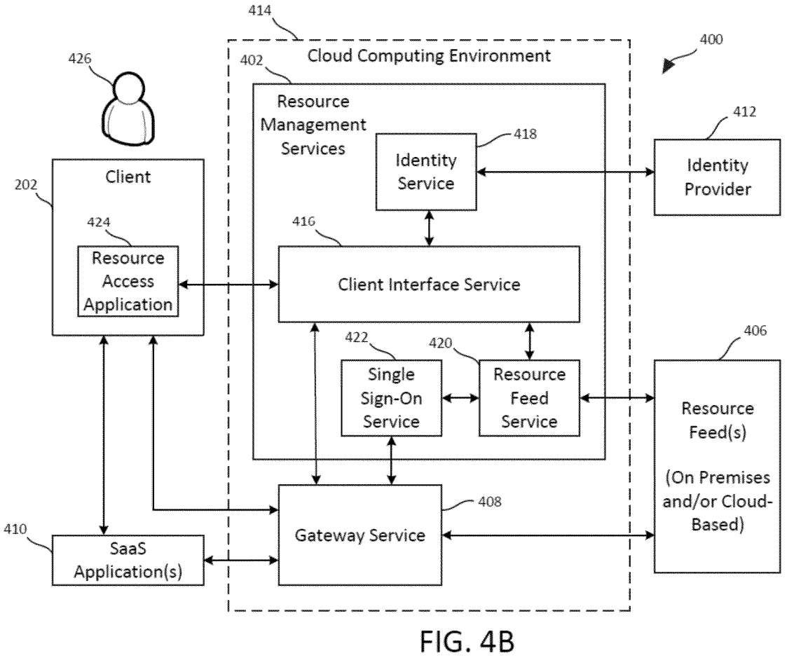

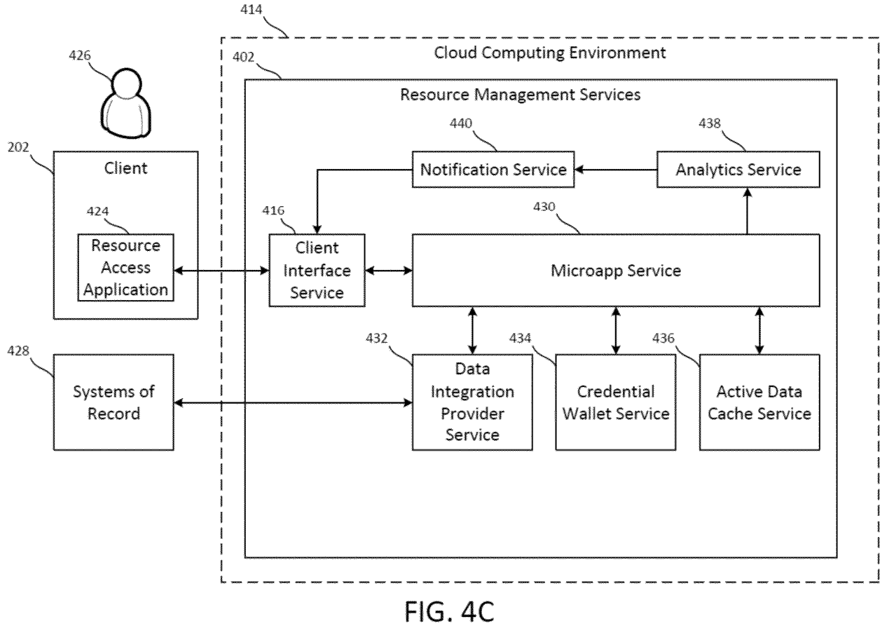

FIG. 4A is a block diagram of an illustrative system 400 in which one or more resource management services 402 may manage and streamline access by one or more clients 202 to one or more resource feeds 406 (via one or more gateway services 408) and/or one or more software-as-a-service (SaaS) applications 410. In particular, resource management service(s) 402 may employ an identity provider 412 to authenticate the identity of a user of a client 202 and, following authentication, identify one of more resources the user is authorized to access. In response to the user selecting one of the identified resources, resource management service(s) 402 may send appropriate access credentials to the requesting client 202, and the requesting client 202 may then use those credentials to access the selected resource. For resource feed(s) 406, client 202 may use the supplied credentials to access the selected resource via gateway service 408. For SaaS application(s) 410, client 202 may use the credentials to access the selected application directly.

Client(s) 202 may be any type of computing devices capable of accessing resource feed(s) 406 and/or SaaS application(s) 410, and may, for example, include a variety of desktop or laptop computers, smartphones, tablets, etc. Resource feed(s) 406 may include any of numerous resource types and may be provided from any of numerous locations. In some embodiments, for example, resource feed(s) 406 may include one or more systems or services for providing virtual applications and/or desktops to client(s) 202, one or more file repositories and/or file sharing systems, one or more secure browser services, one or more access control services for SaaS applications 410, one or more management services for local applications on client(s) 202, one or more internet enabled devices or sensors, etc. Each of resource management service(s) 402, resource feed(s) 406, gateway service(s) 408, SaaS application(s) 410, and identity provider 412 may be located within an on-premises data center of an organization for which system 400 is deployed, within one or more cloud computing environments, or elsewhere.

FIG. 4B is a block diagram showing an illustrative implementation of system 400 shown in FIG. 4A in which various resource management services 402 as well as gateway service 408 are located within a cloud computing environment 414. The cloud computing environment may, for example, include Microsoft Azure Cloud, Amazon Web Services, Google Cloud, or IBM Cloud.

For any of illustrated components (other than client 202) that are not based within cloud computing environment 414, cloud connectors (not shown in FIG. 4B) may be used to interface those components with cloud computing environment 414. Such cloud connectors may, for example, run on Windows Server instances hosted in resource locations and may create a reverse proxy to route traffic between the site(s) and cloud computing environment 414. In the illustrated example, the cloud-based resource management services 402 include a client interface service 416, an identity service 418, a resource feed service 420, and a single sign-on service 422. As shown, in some embodiments, client 202 may use a resource access application 424 to communicate with client interface service 416 as well as to present a user interface on client 202 that a user 426 can operate to access resource feed(s) 406 and/or SaaS application(s) 410. Resource access application 424 may either be installed on client 202 or may be executed by client interface service 416 (or elsewhere in system 400) and accessed using a web browser (not shown in FIG. 4B) on client 202.

As explained in more detail below, in some embodiments, resource access application 424 and associated components may provide user 426 with a personalized, all-in-one interface enabling instant and seamless access to all the user’s SaaS and web applications, files, virtual Windows applications, virtual Linux applications, desktops, mobile applications, Citrix Virtual Apps and Desktops™, local applications, and other data.

When resource access application 424 is launched or otherwise accessed by user 426, client interface service 416 may send a sign-on request to identity service 418. In some embodiments, identity provider 412 may be located on the premises of the organization for which system 400 is deployed. Identity provider 412 may, for example, correspond to an on-premises Windows Active Directory. In such embodiments, identity provider 412 may be connected to the cloud-based identity service 418 using a cloud connector (not shown in FIG. 4B), as described above. Upon receiving a sign-on request, identity service 418 may cause resource access application 424 (via client interface service 416) to prompt user 426 for the user’s authentication credentials (e.g., username and password). Upon receiving the user’s authentication credentials, client interface service 416 may pass the credentials along to identity service 418, and identity service 418 may, in turn, forward them to identity provider 412 for authentication, for example, by comparing them against an Active Directory domain. Once identity service 418 receives confirmation from identity provider 412 that the user’s identity has been properly authenticated, client interface service 416 may send a request to resource feed service 420 for a list of subscribed resources for user 426.

In other embodiments (not illustrated in FIG. 4B), identity provider 412 may be a cloud-based identity service, such as a Microsoft Azure Active Directory. In such embodiments, upon receiving a sign-on request from client interface service 416, identity service 418 may, via client interface service 416, cause client 202 to be redirected to the cloud-based identity service to complete an authentication process. The cloud-based identity service may then cause client 202 to prompt user 426 to enter the user’s authentication credentials. Upon determining the user’s identity has been properly authenticated, the cloud-based identity service may send a message to resource access application 424 indicating the authentication attempt was successful, and resource access application 424 may then inform client interface service 416 of the successfully authentication. Once identity service 418 receives confirmation from client interface service 416 that the user’s identity has been properly authenticated, client interface service 416 may send a request to resource feed service 420 for a list of subscribed resources for user 426.

For each configured resource feed, resource feed service 420 may request an identity token from single sign-on service 422. Resource feed service 420 may then pass the feed-specific identity tokens it receives to the points of authentication for the respective resource feeds 406. Each resource feed 406 may then respond with a list of resources configured for the respective identity. Resource feed service 420 may then aggregate all items from the different feeds and forward them to client interface service 416, which may cause resource access application 424 to present a list of available resources on a user interface of client 202. The list of available resources may, for example, be presented on the user interface of client 202 as a set of selectable icons or other elements corresponding to accessible resources. The resources so identified may, for example, include one or more virtual applications and/or desktops (e.g., Citrix Virtual Apps and Desktops™, VMware Horizon, Microsoft RDS, etc.), one or more file repositories and/or file sharing systems (e.g., Sharefile®, one or more secure browsers, one or more internet enabled devices or sensors, one or more local applications installed on client 202, and/or one or more SaaS applications 410 to which user 426 has subscribed. The lists of local applications and SaaS applications 410 may, for example, be supplied by resource feeds 406 for respective services that manage which such applications are to be made available to user 426 via resource access application 424. Examples of SaaS applications 410 that may be managed and accessed as described herein include Microsoft Office 365 applications, SAP SaaS applications, Workday applications, etc.

For resources other than local applications and SaaS application(s) 410, upon user 426 selecting one of the listed available resources, resource access application 424 may cause client interface service 416 to forward a request for the specified resource to resource feed service 420. In response to receiving such a request, resource feed service 420 may request an identity token for the corresponding feed from single sign-on service 422. Resource feed service 420 may then pass the identity token received from single sign-on service 422 to client interface service 416 where a launch ticket for the resource may be generated and sent to resource access application 424. Upon receiving the launch ticket, resource access application 424 may initiate a secure session to gateway service 408 and present the launch ticket. When gateway service 408 is presented with the launch ticket, it may initiate a secure session to the appropriate resource feed and present the identity token to that feed to seamlessly authenticate user 426. Once the session initializes, client 202 may proceed to access the selected resource.

When user 426 selects a local application, resource access application 424 may cause the selected local application to launch on client 202. When user 426 selects SaaS application 410, resource access application 424 may cause client interface service 416 request a one-time uniform resource locator (URL) from gateway service 408 as well a preferred browser for use in accessing SaaS application 410. After gateway service 408 returns the one-time URL and identifies the preferred browser, client interface service 416 may pass that information along to resource access application 424. Client 202 may then launch the identified browser and initiate a connection to gateway service 408. Gateway service 408 may then request an assertion from single sign-on service 422. Upon receiving the assertion, gateway service 408 may cause the identified browser on client 202 to be redirected to the logon page for identified SaaS application 410 and present the assertion. The SaaS may then contact gateway service 408 to validate the assertion and authenticate user 426. Once the user has been authenticated, communication may occur directly between the identified browser and the selected SaaS application 410, thus allowing user 426 to use client 202 to access the selected SaaS application 410.

In some embodiments, the preferred browser identified by gateway service 408 may be a specialized browser embedded in resource access application 424 (when the resource application is installed on client 202) or provided by one of the resource feeds 406 (when resource access application 424 is located remotely), e.g., via a secure browser service. In such embodiments, SaaS applications 410 may incorporate enhanced security policies to enforce one or more restrictions on the embedded browser. Examples of such policies include (1) requiring use of the specialized browser and disabling use of other local browsers, (2) restricting clipboard access, e.g., by disabling cut/copy/paste operations between the application and the clipboard, (3) restricting printing, e.g., by disabling the ability to print from within the browser, (3) restricting navigation, e.g., by disabling the next and/or back browser buttons, (4) restricting downloads, e.g., by disabling the ability to download from within the SaaS application, and (5) displaying watermarks, e.g., by overlaying a screen-based watermark showing the username and IP address associated with client 202 such that the watermark will appear as displayed on the screen if the user tries to print or take a screenshot. Further, in some embodiments, when a user selects a hyperlink within a SaaS application, the specialized browser may send the URL for the link to an access control service (e.g., implemented as one of the resource feed(s) 406) for assessment of its security risk by a web filtering service. For approved URLs, the specialized browser may be permitted to access the link. For suspicious links, however, the web filtering service may have client interface service 416 send the link to a secure browser service, which may start a new virtual browser session with client 202, and thus allow the user to access the potentially harmful linked content in a safe environment.

In some embodiments, in addition to or in lieu of providing user 426 with a list of resources that are available to be accessed individually, as described above, user 426 may instead be permitted to choose to access a streamlined feed of event notifications and/or available actions that may be taken with respect to events that are automatically detected with respect to one or more of the resources. This streamlined resource activity feed, which may be customized for each user 426, may allow users to monitor important activity involving all of their resources-SaaS applications, web applications, Windows applications, Linux applications, desktops, file repositories and/or file sharing systems, and other data through a single interface, without needing to switch context from one resource to another. Further, event notifications in a resource activity feed may be accompanied by a discrete set of user-interface elements, e.g., “approve,” “deny,” and “see more detail” buttons, allowing a user to take one or more simple actions with respect to each event right within the user’s feed. In some embodiments, such a streamlined, intelligent resource activity feed may be enabled by one or more micro-applications, or “microapps,” that can interface with underlying associated resources using APIs or the like. The responsive actions may be user-initiated activities that are taken within the microapps and that provide inputs to the underlying applications through the API or other interface. The actions a user performs within the microapp may, for example, be designed to address specific common problems and use cases quickly and easily, adding to increased user productivity (e.g., request personal time off, submit a help desk ticket, etc.). In some embodiments, notifications from such event-driven microapps may additionally or alternatively be pushed to clients 202 to notify user 426 of something that requires the user’s attention (e.g., approval of an expense report, new course available for registration, etc.).

FIG. 4C is a block diagram similar to that shown in FIG. 4B but in which the available resources (e.g., SaaS applications, web applications, Windows applications, Linux applications, desktops, file repositories and/or file sharing systems, and other data) are represented by a single box 428 labeled “systems of record,” and further in which several different services are included within the resource management services block 402. As explained below, the services shown in FIG. 4C may enable the provision of a streamlined resource activity feed and/or notification process for client 202. In the example shown, in addition to client interface service 416 discussed above, the illustrated services include a microapp service 430, a data integration provider service 432, a credential wallet service 434, an active data cache service 436, an analytics service 438, and a notification service 440. In various embodiments, the services shown in FIG. 4C may be employed either in addition to or instead of the different services shown in FIG. 4B.

In some embodiments, a microapp may be a single use case made available to users to streamline functionality from complex enterprise applications. Microapps may, for example, utilize APIs available within SaaS, web, or home-grown applications allowing users to see content without needing a full launch of the application or the need to switch context. Absent such microapps, users would need to launch an application, navigate to the action they need to perform, and then perform the action. Microapps may streamline routine tasks for frequently performed actions and provide users the ability to perform actions within resource access application 424 without having to launch the native application. The system shown in FIG. 4C may, for example, aggregate relevant notifications, tasks, and insights, and thereby give user 426 a dynamic productivity tool. In some embodiments, the resource activity feed may be intelligently populated by utilizing machine learning and artificial intelligence (AI) algorithms. Further, in some implementations, microapps may be configured within cloud computing environment 414, thus giving administrators a powerful tool to create more productive workflows, without the need for additional infrastructure. Whether pushed to a user or initiated by a user, microapps may provide short cuts that simplify and streamline key tasks that would otherwise require opening full enterprise applications. In some embodiments, out-of-the-box templates may allow administrators with API account permissions to build microapp solutions targeted for their needs. Administrators may also, in some embodiments, be provided with the tools they need to build custom microapps.

Referring to FIG. 4C, systems of record 428 may represent the applications and/or other resources resource management services 402 may interact with to create microapps. These resources may be SaaS applications, legacy applications, or homegrown applications, and can be hosted on-premises or within a cloud computing environment. Connectors with out-of-the-box templates for several applications may be provided and integration with other applications may additionally or alternatively be configured through a microapp page builder. Such a microapp page builder may, for example, connect to legacy, on-premises, and SaaS systems by creating streamlined user workflows via microapp actions. Resource management services 402, and in particular data integration provider service 432, may, for example, support REST API, JSON, OData-JSON, and 6ML. As explained in more detail below, data integration provider service 432 may also write back to the systems of record, for example, using OAuth2 or a service account.

In some embodiments, microapp service 430 may be a single-tenant service responsible for creating the microapps. Microapp service 430 may send raw events, pulled from systems of record 428, to analytics service 438 for processing. The microapp service may, for example, periodically pull active data from systems of record 428.

In some embodiments, active data cache service 436 may be single-tenant and may store all configuration information and microapp data. It may, for example, utilize a per-tenant database encryption key and per-tenant database credentials.

In some embodiments, credential wallet service 434 may store encrypted service credentials for systems of record 428 and user OAuth2 tokens.

In some embodiments, data integration provider service 432 may interact with systems of record 428 to decrypt end-user credentials and write back actions to systems of record 428 under the identity of the end-user. The write-back actions may, for example, utilize a user’s actual account to ensure all actions performed are compliant with data policies of the application or other resource being interacted with.

In some embodiments, analytics service 438 may process the raw events received from microapps service 430 to create targeted scored notifications and send such notifications to notification service 440.

Finally, in some embodiments, notification service 440 may process any notifications it receives from analytics service 438. In some implementations, notification service 440 may store the notifications in a database to be later served in a notification feed. In other embodiments, notification service 440 may additionally or alternatively send the notifications out immediately to client 202 as a push notification to user 426.

In some embodiments, a process for synchronizing with systems of record 428 and generating notifications may operate as follows. Microapp service 430 may retrieve encrypted service account credentials for systems of record 428 from credential wallet service 434 and request a sync with data integration provider service 432. Data integration provider service 432 may then decrypt the service account credentials and use those credentials to retrieve data from systems of record 428. Data integration provider service 432 may then stream the retrieved data to microapp service 430. Microapp service 430 may store the received systems of record data in active data cache service 436 and also send raw events to analytics service 438. Analytics service 438 may create targeted scored notifications and send such notifications to notification service 440. Notification service 440 may store the notifications in a database to be later served in a notification feed and/or may send the notifications out immediately to client 202 as a push notification to user 426.

In some embodiments, a process for processing a user-initiated action via a microapp may operate as follows. Client 202 may receive data from microapp service 430 (via client interface service 416) to render information corresponding to the microapp. Microapp service 430 may receive data from active data cache service 436 to support that rendering. User 426 may invoke an action from the microapp, causing resource access application 424 to send that action to microapp service 430 (via client interface service 416). Microapp service 430 may then retrieve from credential wallet service 434 an encrypted Oauth2 token for the system of record for which the action is to be invoked and may send the action to data integration provider service 432 together with the encrypted Oath2 token. Data integration provider service 432 may then decrypt the Oath2 token and write the action to the appropriate system of record under the identity of user 426. Data integration provider service 432 may then read back changed data from the written-to system of record and send that changed data to microapp service 430. Microapp service 432 may then update active data cache service 436 with the updated data and cause a message to be sent to resource access application 424 (via client interface service 416) notifying user 426 that the action was successfully completed.

In some embodiments, in addition to or in lieu of the functionality described above, resource management services 402 may provide users the ability to search for relevant information across all files and applications. A simple keyword search may, for example, be used to find application resources, SaaS applications, desktops, files, etc. This functionality may enhance user productivity and efficiency as application and data sprawl is prevalent across all organizations.

In other embodiments, in addition to or in lieu of the functionality described above, resource management services 402 may enable virtual assistance functionality that allows users to remain productive and take quick actions. Users may, for example, interact with the “Virtual Assistant” and ask questions such as “What is Bob Smith’s phone number?” or “What absences are pending my approval?” Resource management services 402 may, for example, parse these requests and respond because they are integrated with multiple systems on the backend. In some embodiments, users may be able to interact with the virtual assistance through either resource access application 424 or directly from another resource, such as Microsoft Teams. This feature may allow employees to work efficiently, stay organized, and deliver only the specific information they’re looking for.

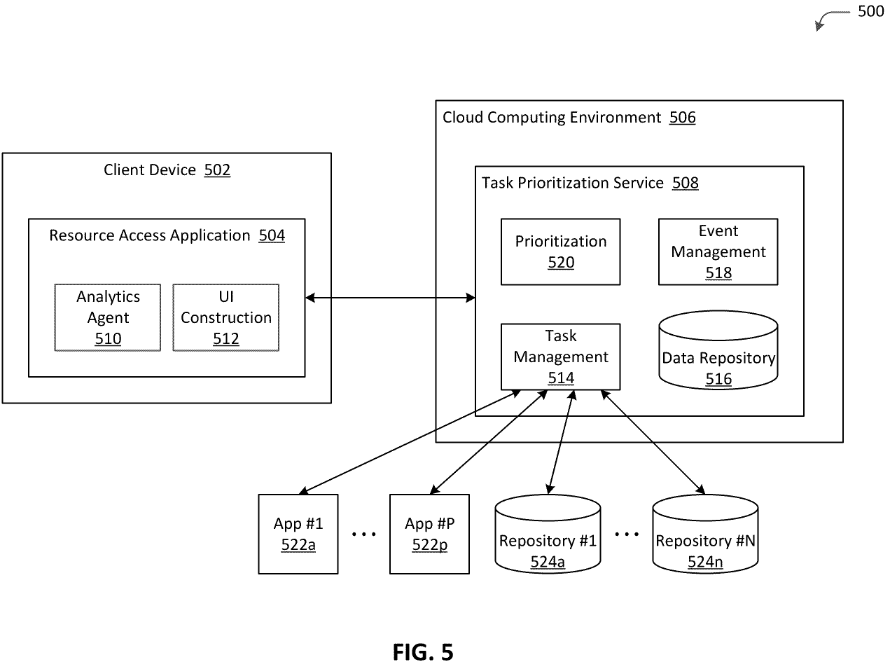

FIG. 5 is a block diagram of an illustrative system 500 for automatically prioritizing tasks, in accordance with an embodiment of the present disclosure. In more detail, system 500 can prioritize tasks assigned to one or more particular users. System 500 includes a resource access application 504 installed on a client device 502 and configured to communicate with a cloud computing environment 506 via one or more computer networks. Client device 502, resource access application 504, and cloud computing environment 506 of FIG. 5 can be the same as or similar to client 202, resource access application 424, and cloud computing environment 414, respectively, of FIGS. 4A-4C.

As shown in FIG. 5, a task prioritization service 508 can be provided as a service (e.g., a microservice) within cloud computing environment 506. Resource access application 504 and task prioritization service 508 can interoperate to determine tasks that are assigned to or otherwise associated with a user, prioritize the tasks based on one or more factors, and present the prioritized tasks to the user by displaying the tasks on client device 502, for example. In some embodiments, prioritizing tasks can include sorting the tasks based on priorities (“priority values”) and/or grouping tasks based on dependencies therebetween. In some embodiments, the tasks associated with the user may be re-prioritized and presented to the user in response to an input (e.g., in response to an activation of a “refresh” button). Additionally or alternatively, the tasks associated with the user may be re- prioritized and presented to the user in response to detecting a change to the tasks associated with the user. In any case, the prioritized tasks may be presented to the user to assist the user in performing the assigned tasks, for example.

To promote clarity in the drawings, FIG. 5 shows a single resource access application 504 communicably coupled to task prioritization service 508. However, embodiments of task prioritization service 508 can be used to service many resource access applications (e.g., resource access application 504) installed on clients (e.g., client devices 502) associated with one or more organizations. Resource access application 504 and/or task prioritization service 508 may be implemented as computer instructions executable to perform the corresponding functions disclosed herein. Resource access application 504 and task prioritization service 508 can be logically and/or physically organized into one or more components. In the example of FIG. 5, resource access application 504 includes an analytics agent 510 and a UI construction module 512. Also, in this example, task prioritization service 508 includes a task management module 514, a data repository 516, an event management module 518, and a prioritization module 520.

The client-side resource access application 504 can communicate with the cloud-side task prioritization service 508 using an API. For example, resource access application 504 can send requests (or “messages”) to task prioritization service 508 wherein the requests are received and processed by task prioritization service 508 or one or more components of task prioritization service 508. Likewise, task prioritization service 508 can send responses/messages to resource access application 504 wherein the responses/messages are received and processed by resource access application 504 or one or more components of resource access application 504. In some embodiments, task prioritization service 508 can push information to resource access application 504.

Referring to the client-side resource access application 504, analytics agent 510 and UI construction module 512 can be provided as sub-modules or other components of resource access application 504. Analytics agent 510 is operable to receive information regarding prioritized tasks from task prioritization service 508. The prioritized tasks may be associated with a particular user (e.g., a user of resource access application 504 on client device 502). Upon receiving the information regarding prioritized tasks, analytics agent 510 can send or otherwise provide the prioritized tasks and/or information regarding the prioritized tasks to UI construction module 512 for presenting on client device 502.

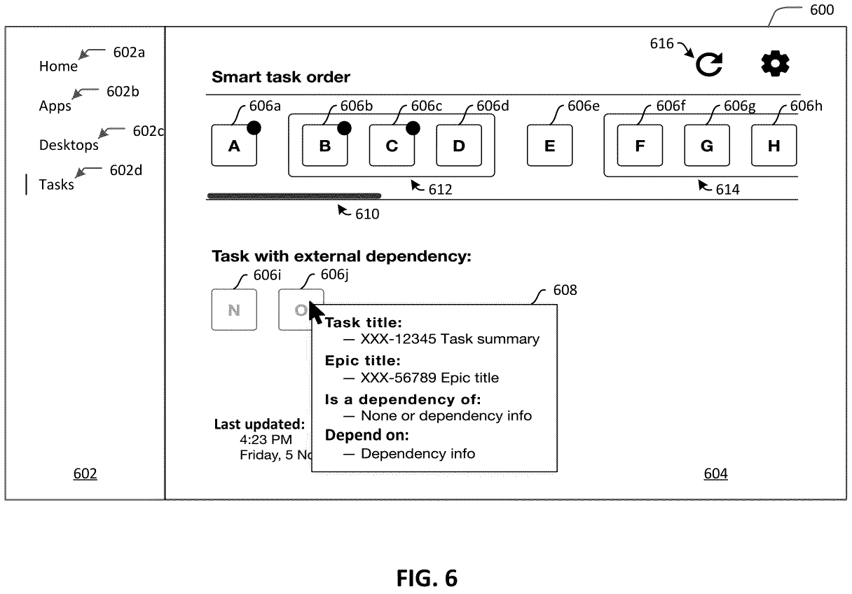

In response to receiving the prioritized tasks, UI construction module 512 is operable to visually render/display the prioritized tasks and other information regarding the tasks on client device 502. In more detail, UI construction module 512 can organize the received information regarding the prioritized tasks into a data format that can be rendered/displayed within or as part of a UI, such as a UI of resource access application 504. For example, in one embodiment, UI construction module 512 can organize the information regarding the prioritized tasks using various UI elements that enable a user to view an ordered arrangement or list of tasks assigned to the user and readily interact with and/or access information regarding the assigned tasks. A user of client device 502 can view and interact with the rendered/displayed information regarding the prioritized tasks within the UI of resource access application 504 to efficiently perform the assigned tasks. An example UI page for presenting prioritized tasks is further described below with respect to FIG. 6.

Referring to the cloud-side task prioritization service 508, task management module 514 is operable to collect/retrieve information regarding tasks (e.g., tasks assigned to users) along with other information regarding the tasks from one or more data sources. The data sources can include, for example, one or more applications 522a-522p (individually referred to herein as application 522 or collectively referred to herein as applications 522) and one or more repositories 524a-524n (individually referred to herein as repository 524 or collectively referred to herein as repositories 524). Applications 522 can include various types of applications such as SaaS applications, web applications, and desktop applications. In some embodiments, applications 522 may correspond to product/project management applications such as WRIKE, JIRA, BASECAMP, and TRELLO. In some embodiments, repositories 524 can include various types of data repositories such as conventional file systems, cloud-based storage services such as SHAREFILE, BITBUCKET, DROPBOX, and MICROSOFT ONEDRIVE, and web servers that host files, documents, and other materials.

Task management module 514 may utilize APIs provided by the various data sources to collect/retrieve the items of information therefrom. For example, task management module 514 may use a REST-based API provided by a SaaS application to collect/retrieve the items of information therefrom (e.g., a REST-based API provided by JIRA to retrieve tickets and information about the tickets from JIRA). As another example, task management module 514 may use a REST-based API provided by TRELLO to collect/retrieve tickets and information about the tickets from TRELLO. As yet another example, task management module 514 may use a file system interface to collect/retrieve files containing information regarding tasks from a file system. As yet another example, task management module 514 may use an API to download documents containing information regarding tasks from a cloud-based storage service.

A particular data source (e.g., application 522 or repository 524) can be hosted within a cloud computing environment (e.g., cloud computing environment 506 or a different cloud computing environment) or within an on-premises data center (e.g., an on-premises data center of an organization that utilizes task prioritization service 508).

The particular data sources (e.g., applications 522 and repositories 524) from which task management module 514 can collect/retrieve the items of information can vary between different organizations. In some embodiments, task management module 514 can obtain a list of data sources used by a particular organization and/or user. For example, some organizations serviced by task prioritization service 508 may use JIRA as a project management application whereas other organizations may use TRELLO. As another example, some organizations serviced by task ordering service 508 may use SHAREFILE and BITBUCKET as data repositories whereas other organizations may use MICROSOFT ONEDRIVE. Task management module 514 can determine the particular data sources from which to collect/retrieve the items of information from based on configuration information maintained for the organization and/or user. In some embodiments, task management module 514 may obtain a list of subscribed resources (e.g., applications and services) for a particular organization via resource feed service 420 of FIG. 4B. Task management module 514 may also obtain authentication credentials (e.g., user ids and passwords, access tokens, etc.) which may be needed to access one of more of the data sources for collecting/retrieving the items of information and other data. In some embodiments, task management module 514 may use a single sign-on service (e.g., service 422 of FIG. 4B) to access one or more such data sources.

As mentioned previously, task management module 514 can collect/retrieve information regarding tasks along with other information regarding the tasks from one or more data sources. Such information is sometimes referred to herein as “task information.” Task information can include, for a particular task, information such as an identifier (e.g., task id), a project/space/epic to which the task belongs, a user who created the task, a user (i.e., an assignee) to whom the task is assigned, a deadline (e.g., a date by which the task is to be completed), a business value of the task (e.g., an importance of the task), dependencies (e.g., other tasks that this task depends on), a status of the task, and a description of the task. These examples of task information are merely illustrative and may vary depending on the capabilities of the product/project management application(s) utilized by the organization. Some or all the task information may be specified by a creator of the task. Task management module 514 can store the task information collected from the data sources within data repository 516 that can correspond to, for example, a storage service within cloud computing environment 506.

In some embodiments, task management module 514 can collect/retrieve task information from the data sources on a continuous or periodic basis (e.g., according to a predetermined schedule such as, for example, every 30 minutes, 1 hour, 2 hours, or any other suitable period of time). Additionally or alternatively, a data source (e.g., application 522 or repository 524) can send or otherwise provide task information to task management module 514 in response to an even on the data source (e.g., a task being completed; a change in status of a task, a new task being generated, etc.).

Event management module 518 is configured to initiate the prioritization of tasks associated with a user. In some embodiments, event management module 518 can initiate the prioritization of tasks associated with a user in response to an input. For example, a user of resource access application 504 may click/tap a link or other UI element displayed within a UI of resource access application 504 to access a UI page displaying an ordered arrangement of the tasks associated with the user (e.g., a list of the tasks assigned to the user). In response to such input, resource access application 504 can send a request to task prioritization service 508 that causes event management module 518 to initiate prioritization of the tasks associated with the user. As another example, a user of resource access application 504 may click/tap a “refresh” button in a UI page displaying an ordered arrangement of the user’s tasks to refresh the display of the prioritized tasks (e.g., to cause the user’s task to be re-prioritized). In response to such input, resource access application 504 can send a request to task prioritization service 508 that causes event management module 518 to initiate prioritization of the tasks associated with the user. In any case, event management module 518 can send a request to prioritization module 520 that causes prioritization module 520 to prioritize the tasks associated with the user.

In some embodiments, event management module 518 can initiate the prioritization of tasks associated with a user in response to determining or detecting a change in the status of the tasks associated with the user. For example, event management module 518 may monitor the organization’s product/project management application(s) for task status changes (e.g., creation of new tasks, completion of tasks, cancelation of tasks, etc.). As another example, a product/project management application may send a notification of a task status change to event management module 518. The notification provided by the product/project management application may indicate or otherwise identify the particular task whose status changed. In response determining a change in the status of tasks associated with a user, event management module 518 can send a request to prioritization module 520 that causes prioritization module 520 to prioritize the tasks associated with the user.

In response to receiving a request to prioritize tasks associated with a user, prioritization module 520 can prioritize the tasks associated with the user according to priorities of the tasks and/or dependencies between the tasks. To prioritize the user’s tasks, prioritization module 520 can retrieve information regarding the user’s tasks from data repository 516. The prioritized tasks can then be presented (or “recommended”) to the user so that the user can readily understand the importance of the individual tasks relative to one another and an optimal sequence in which the user can perform the tasks. In some embodiments, for the tasks associated with a given user, prioritization module 520 can prioritize the tasks based on priority and/or grouping of tasks based on dependencies therebetween. For a particular task, the priority may be based on the deadline and the business value specified for the task. The business value specified for a task (e.g., business value specified by a creator of a task) may be referred to as an “actual importance.” The dependencies may specify any the other task(s) that this task is dependent on (e.g., the dependencies may identify the other task(s) that this task has a dependency on, and which need to be completed before this task can be performed). Such other tasks that a task depends on is referred to herein as “dependent tasks.” The dependent tasks may be assigned to the user (i.e., the same user) or to a different user. In some embodiments, prioritization module 520 can identify and group the tasks that are related to one another in a task group. The related tasks are the tasks that have the same dependency relationship (or “dependency line”). For example, suppose Task A is dependent on Task B which is dependent on Task C, and Task X is dependent on Task Y. In this example, prioritization module 520 can group Task A, Task B, and Task C in one task group and group Task X and Task Y in another task group. Prioritization module 520 can then calculate or otherwise determine a priority for the single tasks (i.e., the tasks which do not have any dependencies) and the task groups and sort the user’s tasks based on the respective priorities of the single tasks and the respective priorities of the task groups.

In some embodiments, a priority of a task may be a weighted sum of the deadline and the business value specified for the task. For example, to calculate a priority for particular task, prioritization module 520 can apply a predetermined weight to the specified deadline and a predetermined weight to the specified business value. Prioritization module 520 can then calculate a weighted sum of the deadline and the business value as the priority of the task. The individual weights applied to the deadline and business value in computing the weighted sum may be defined by the organization.

In some embodiments, prioritization module 520 can calculate a priority for a task based on a normalized deadline and a normalized business value. For example, in one embodiment, prioritization module 520 can calculate a normalized deadline of a task is based on a number of working days in a predetermined time period, the deadline specified for the task (e.g., the deadline specified by the task creator and indicated in the task ticket), and a current date (e.g., the date the user’s tasks are being prioritized). The working days may be the days the user is required to work (e.g., Monday through Friday excluding national and regional holidays), and may be specified by the organization. The predetermined time period may be a project or program iteration, such as 2 weeks, 4 weeks, or 6 weeks, during which task are performed to achieve a goal (e.g., a duration during which development takes place). The predetermined time period may be defined by the organization and is a time period within which the tasks associated with the user needs to be completed. The predetermined time period can vary between different organizations. The normalized business value of a task may be a business value adjusted and/or scaled to a range of business values, such as the range of business values specified for all the tasks associated with a user.

In some embodiments, for the tasks associated with a given user, prioritization module 520 can identify the tasks that have dependencies on a task or tasks assigned to another user (e.g., a user different or other than the user associated with the tasks that are being prioritized). Such dependency on a task or tasks assigned to a different user is referred to herein as an “external dependency.” For example, suppose a Task A assigned to a first user is dependent on a Task B which is assigned to a second user different than the first user. In this example, Task A can be understood to have an external dependency. Having identified the task that have external dependencies, prioritization module 520 can group the tasks based on whether or not a task has an external dependency (e.g., place the tasks that do not have an external dependency in one group and place the tasks that have an external dependency in another group), and sort the tasks within each group.

In some embodiments, prioritization module 520 can calculate an average priority within each task block. Prioritization module 520 can then use the respective average priorities of the task blocks when prioritizing the tasks associated with a user. In other words, prioritization module 520 can prioritize a user’s tasks based on the respective priorities of the single tasks and the respective average priorities of the task groups.

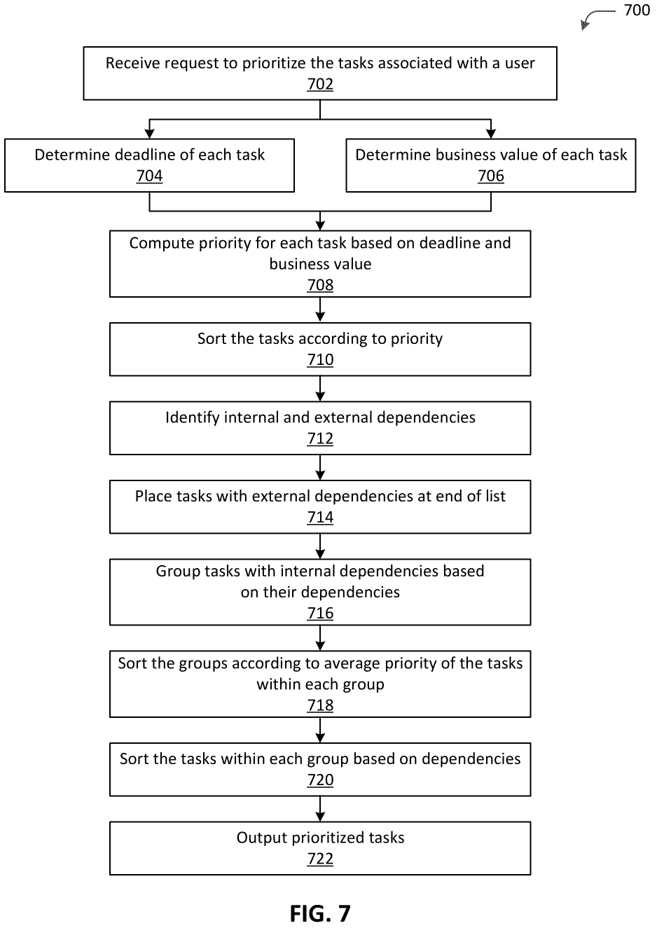

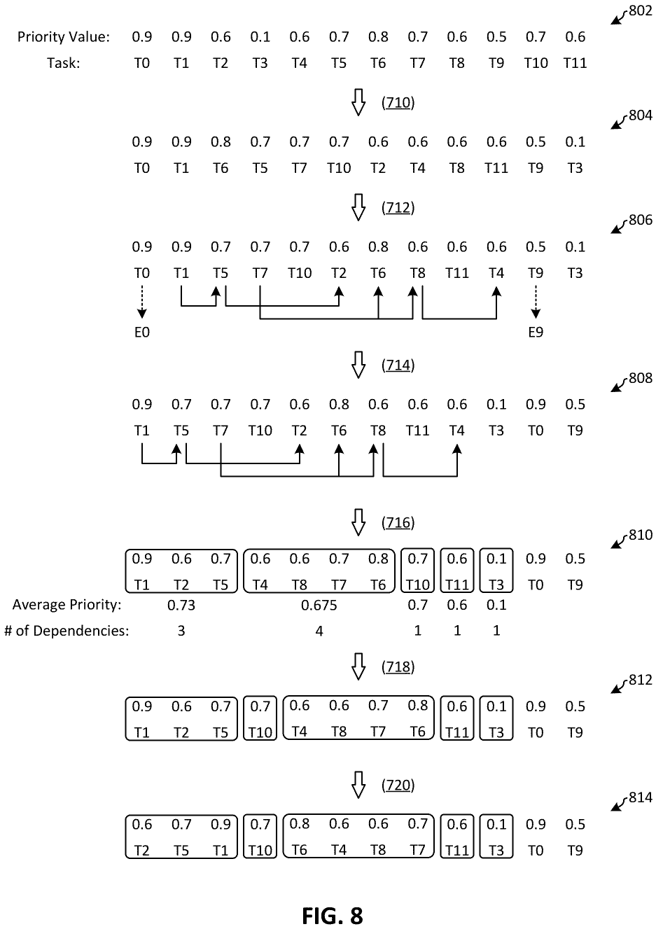

In some embodiments, prioritization module 520 can sort the tasks within the individual task blocks, for example, using a topological algorithm. Once sorted using such a manner, the tasks in the individual task blocks may be linearly arranged according to their dependencies (e.g., a task appears - e.g., is given a higher priority -before all the tasks which have a dependency on the task in the linear arrangement or order). In some embodiments, prioritization module 520 can sort the task blocks based on the number of tasks that are in the individual task blocks. For example, a task block which includes a smaller number of tasks appears - e.g., is given a higher priority - than a task block which includes a larger number of tasks. Further description of the sorting algorithms and other processing that can be implemented within prioritization module 520 is further described below at least with respect to FIGS. 7 and 8.

FIG. 6 is a diagram of an illustrative user interface (UI) 600 for presenting prioritized tasks associated with a user, in accordance with an embodiment of the present disclosure. For example, illustrative UI 600 UI 600 may be implemented within the system 500 of FIG. 5 and, more particularly, within resource access application 504 of FIG. 5. As shown, UI 600 includes a menu pane 602 and a task view pane 604. Control pane 602 can include a home menu item 602a, an applications menu item 602b, a desktops menu item 602c, and a tasks menu item 602d. A user may click/tap on menu items 602a-602d to access corresponding functionality of the resources access application. The first three menu items 602a-602c may be used to access functionality of an existing resource access application, such as access to remote applications (menu item 602b) and remote desktops (menu item 602c). Tasks menu item 602d can be used for generating, viewing, and interacting with tasks prioritized according to the present disclosure.

In response to a user clicking/tapping tasks menu item 602d, UI 600 can display task view pane 604. Task view pane 604 can show the tasks and information regarding the tasks associated with the user in a ordered arrangement. As mentioned previously, in one embodiment, the arrangement of tasks and the information regarding the tasks displayed within task view pane 604 may be rendered by UI construction module 512 of FIG. 5.

As shown in FIG. 6, task view pane 604 can include buttons 606a-606j (606 generally) representing task A, task B, task C, task D, task E, task F, task G, task H, task N, and task O, respectively. Tasks A, B, C, D, E, F, G, H, N, O displayed within task view pane 604 may be some or all the user’s tasks. Any of the displayed buttons 606 can be clicked/tapped to access the corresponding task. For example, the user can click/tap button 606a to cause task A and information regarding task A (e.g. a task ticket corresponding to task A) to be displayed on client device 502 (e.g., task A and information about task A may be displayed in a default bowser window). The user may then view the displayed information regarding task A and, in some cases, interact with the displayed information. One or more of the buttons 606 may be configured to display information about the corresponding task in response to a user input. For example, in response to a mouse or other pointing device being hovered over button 606j, a text box 608 can be presented that displays a concise summary (or “infotip”) of task O. In the example shown in FIG. 6, text box 608 can display a title and summary of task O (“Task title:”), an epic to which task O belongs (“Epic title: XXX-56789 Epic title”), any other tasks depending on task O (“Is a dependency of: None or dependency info”), and the dependent tasks that task O is dependent on (:Depend on: Dependency info”). The information displayed within text box 608 allows the user to recall or determine the specifics of task O.

In the example shown, tasks A, B, C, D, E, F, G, H may be the user’s tasks that do not have external dependencies and may be displayed apart from tasks N, O which may be the user’s tasks that have external dependencies. As shown by the position of a slide control 610, the user may have other tasks that do not have external dependencies, and which are not displayed within task view pane 604. Slide control 610 may be moved to display the user’s other tasks which are not currently displayed within task view pane 604. According to embodiments disclosed herein, the user’s tasks A, B, C, D, E, F, G, H can be prioritized based on the priority of the individual tasks and/or dependencies between the tasks, and displayed within task view pane 604 in order according to the prioritization. In other words, task view pane 604 displays tasks A, B, C, D, E, F, G, H in a recommended order in which the user can perform or complete the user’s tasks (e.g., suggested order in which tasks A, B, C, D, E, F, G, H can be performed or completed). For example, the tasks may be displayed left to right in decreasing priority within task view pane 604. In the example of FIG. 6, task A (represented by button 606a) is shown to have a higher priority than task E (represented by button 606e), and task N (represented by button 606i) is shown to have a higher priority than task O (represented by button 606j). In some embodiments, task view pane 604 can display an additional visual representation (e.g., a dot or any other glyph) to indicate tasks which have changed priority or position in the ordering from the preceding prioritization. In the example of FIG. 6, tasks A, B, C are shown to have changed priority from their respective priorities in the immediately preceding ordering as indicated by the circular dot displayed at the upper right corner of buttons 606a, 606b, 606c.

In some embodiments, task view pane 604 can include visual representations (e.g., boxes) to indicate task groups and the tasks in or belonging to each task group. In the example of FIG. 6, tasks B, C, D are shown to belong to a task group as indicated by a box 612 and tasks F, G, H are shown to belong to another task group as indicated by a box 614. Note that, in the example shown, the task group represented by box 614 includes other tasks in addition to tasks F, G, H, as indicated by the visual omission of a right border of box 614. Task view pane 604 can also display the tasks in the task blocks in topological order. In the example of FIG. 6, within task view pane 604 and, in particular, box 612, task D (represented by button 606d) is shown to have a dependency on task C (represented by button 606c), which is shown to have a dependency on task B (represented by button 606b). Based on these dependencies, within box 612, task B (represented by button 606b) is displayed in the left-most position to show task B has a higher priority than task C (represented by button 606c) and task D (represented by button 606d), and task C is displayed to the left of task to show that task C has a higher priority than task D.

As mentioned previously, task view pane 604 may display the user’s tasks left to right in a recommended order in which the user can perform or complete the tasks. In the example of FIG. 6, task A (represented by button 606a) is shown to have a higher priority than the task group that includes tasks B, C, D (represented by box 612), which is shown to have a higher priority than task E (represented by button 606e), which is shown to have a higher priority than the task group that includes tasks F, G, H (represented by box 614). Task view pane 604 can also include a refresh button 616. The user may click/tap on refresh button 616 to refresh the display of task view pane 604 (e.g., refresh the prioritization of the user’s tasks). In response to the user clicking/tapping refresh button 616, the resource access application 504 can send a request to event management module 518 to re-prioritize the user’s tasks (e.g., send a message to event management system 518 to provide a re-prioritized arrangement of the tasks associated with the user).

FIG. 7 is a flow diagram illustrating an illustrative process 700 for prioritizing tasks associated with a user, in accordance with an embodiment of the present disclosure. Process 700 may be implemented, for example, within a cloud computing service, such as task prioritization service 508 of FIG. 5.

Referring to process 700 and with reference to the example illustrated in FIG. 8, at 702, a request to prioritize tasks associated with a user can be received. The request may be received by a prioritization module (e.g., prioritization module 520 of FIG. 5). The request can include a unique identifier of the user which can be used to retrieve the information regarding the tasks associated with the user. Such information regarding the tasks associated with the user (i.e., the task information pertaining to the tasks associated with the user) can be retrieved from a data repository (e.g., data repository 516 of FIG. 5).

At 704, the deadline of each task associated with the user can be determined. At 706, the business value (i.e., the actual importance) of each task associated with the user can be determined. For the individual tasks associated with the user, the deadline of the task and the actual importance of the task may be determined from the task information retrieved from the data repository.

At 708, for each task associated with the user, a priority (i.e., a priority score) can be computed based on the task’s deadline and business value. In some embodiments, the deadline and business value used to calculate the priorities of the tasks may be normalized values (e.g., normalized across all the tasks associated with the user). The normalized deadline for a given task may be computed as follows:

$$d d l = \left(T p - \left(T d - T c\right)\right) / T p ,$$

where Tp is the number of working days in the current project or program iteration (e.g., number of working days in a predetermined time period), Td is the deadline specified for the task (e.g., the deadline specified by the task creator and indicated in the task ticket), Tc is the current date, and ddl is the normalized deadline of the task.

The normalized business value for a given task may be computed as follows:

$$b v = W / W m ,$$

where W is the business value specified for the task (i.e., actual importance of the task), Wm is the maximum business value (e.g., largest business value) specified for a task associated with the user, and bv is the normalized business value of the task (i.e., the normalized importance of the task). The priority for a given task may then be computed as follows:

$$p = d l l ∗ α + b v ∗ \left(1 - α\right) ,$$

where α is a weighting factor. For example, the weighting factor may be set to 0.5 (e.g., α = 0.5) to give equal weight to the normalized deadline and the normalized business value. The weighting factor can be adjusted to give more importance (more weight) to ether the normalized deadline or the normalized business value in computing a priority of a given task.

In the example of FIG. 8, twelve (12) tasks T0 to T11 may currently be assigned to the user. Based on such computation, task T0 may have a priority value of 0.9, task T1 may have a priority value of 0.9, task T2 may have a priority value of 0.6, task T3 may have a priority value of 0.1, task T4 may have a priority value of 0.6, task T5 may have a priority value of 0.7, task T6 may have a priority value of 0.8, task T7 may have a priority value of 0.7, task T8 may have a priority value of 0.6, task T9 may have a priority value of 0.5, task T10 may have a priority value of 0.7, and task T11 may have a priority value of 0.6. (See reference numeral 802 in FIG. 8.)

At 710, the tasks associated with the user can be sorted according to their computed priorities. In the example of FIG. 8, based on their computed priorities, tasks T0 to T11 may be sorted from highest priority to lowest priority, as follows: task T0, task T1, task T6, task T5, task T7, task T10, task T2, task T4, task T8, task T11, task T9, and task T3. (See reference numeral 804 in FIG. 8.) At 710, the tasks having the same priority (e.g., task T5, task T7, task T10) may be arbitrarily ordered in the list (e.g., task T5, task T7, task T10, or task T7, task T5, task T10, or task T10, task T5, task T7, etc.). (See reference numeral 804 in FIG. 8.)

At 712, the internal and external dependencies of the tasks can be identified (e.g. determined). For the individual tasks associated with the user, any internal and external dependencies may be determined from the task information retrieved from the data repository. For a given task assigned to the user, an internal dependency is a dependency on another task that is assigned to the user, and an external dependency is a dependency on another task that is not assigned to the user. In the example of FIG. 8, as indicated by the dashed directional lines, it may be determined that task T0 has an external dependency on a task E0 (i.e., task T0 is dependent on another task E0 which is assigned to another user) and task T9 has an external dependency on another task E9. As indicated by the solid directional lines, it may also be determined that task T1 has an internal dependency on task T5 which further has an internal dependency on task T2, task T7 has an internal dependency on task T6 and task T8, and task T8 has an internal dependency on task T4. (See reference numeral 806 in FIG. 8.)

At 714, the tasks associated with the user which have external dependencies can be separated from the tasks that do not have external dependencies. For example, the tasks having external dependencies may be placed at the end of the list. In the example of FIG. 8, task T0 and task T9 may be placed at the end of the list (e.g., after task T3). (See reference numeral 808 in FIG. 8.)

At 716, the tasks associated with the user having internal dependencies can be grouped based on their dependencies (e.g., grouped into separate task groups). In the example of FIG. 8, the related tasks T1, T2, T5 may be grouped into a first task group, the related tasks T4, T8, T7, T6 may be grouped into a second task group, task T10 may be grouped into a third task group (i.e., grouped into its own task group since it is not related to any other task), task T11 may be grouped into a fourth task group, and task T3 may be grouped into a fifth task group. (See reference numeral 810 in FIG. 8.) In some embodiments, the tasks having external dependencies can also be grouped based on their dependencies. For example, task T0 may be grouped into a task group (e.g., a sixth task group) and task T9 may be grouped into another task group (e.g., a seventh task group). (See reference numeral 810 in FIG. 8.)

At 718, the individual groups of tasks can be sorted according to average priority of the tasks within each group (e.g., sorted according to average priority value of the tasks contained within each task group). In the example of FIG. 8, the average priority of the first task group (i.e., the task group that includes tasks T1, T2, T5) is 0.73, the average priority of the second task group (i.e., the task group that includes tasks T4, T8, T7, T6) is 0.675, the average priority of the third task group (i.e., the task group that includes task T10) is 0.7, the average priority of the fourth task group (i.e., the task group that includes task T11) is 0.6, and the average priority of the fifth task group (i.e., the task group that includes task T3) is 0.1. The task groups, including the task groups that contain a single task, can then be sorted according to their computed average priorities. In the example of FIG. 8, based on their computed average priorities, the task groups may be sorted from highest average priority to lowest average priority, as follows: the first task group (i.e., the task group that includes tasks T1, T2, T5), the third task group (i.e., the task group that includes task T10), the second task group (i.e., the task group that includes tasks T4, T8, T7, T6), the fourth task group (i.e., the task group that includes task T11), and the fifth task group (i.e., the task group that includes task T3). (See reference numeral 812 in FIG. 8.)

In some embodiments, the task groups containing tasks having external dependencies can also be sorted according to average priority of the tasks within each group. In some embodiments, in cases where there are multiple (i.e., two or more) tasks groups that have the same average priority, these task groups can be further sorted based on the number of tasks within each task group (e.g., the task groups may be sorted based on the number of tasks contained in the individual task groups). For example, suppose a task group X and a task group Y have the same average priority. Also suppose that task group X contains four (4) related tasks and task group Y contains two (2) related tasks. In this example, task group Y may be ordered higher in the list than task group X since task group Y contains a smaller number of tasks than task group X (e.g., task group Y may be given priority over task group X in the list).

At 720, the tasks within the individual task blocks can be sorted based on their dependencies. Sorted in such manner, within each task group, a task is given a higher priority than all the other tasks which have a dependency on the task. In the example of FIG. 8, within the first task group (i.e., the task group that includes tasks T1, T2, T5), the tasks may be sorted T2, T5, then T1; within the third task group (i.e., the task group that includes task T10), the task may be sorted T10 since the third task group contains a single task; within the second task group (i.e., the task group that includes tasks T4, T8, T7, T6), the tasks may be sorted T6, T4, T8, then T7; within the fourth task group (i.e., the task group that includes task T11), the task may be sorted T11 since the fourth task group contains a single task; and the fifth task group (i.e., the task group that includes task T3), the task may be sorted T3 since the fifth task group contains a single task. (See reference numeral 814 in FIG. 8.)

At 722, the prioritized tasks associated with the user can be output. The prioritized tasks may be output by the prioritization module (e.g., prioritization module 520 of FIG. 5) and sent to an analytics agent running on a client device (e.g., analytics agent 510 of FIG. 5). The prioritized tasks may then be presented to the user on the client device (e.g., displayed on the client device for viewing by the user).

### Further Example Embodiments

The following examples pertain to further embodiments, from which numerous permutations and configurations will be apparent.

Example 1 includes a method including: determining, by a first computing device, a plurality of tasks associated with a user; determining, by the first computing device, a priority of each task of the plurality of tasks based on a deadline and an importance of the task; determining, by the first computing device, dependencies between different ones of the plurality of tasks; sorting, by the first computing device, the plurality of tasks based on the priority of each task of the plurality of tasks and the determined dependencies; and causing, by the first computing device, at least a portion of the sorted plurality of tasks to be displayed in a user interface (UI) of an application on a second computing device.

Example 2 includes the subject matter of Example 1, wherein determining the priority of a task includes calculating a weighted sum of the deadline and the importance of the task.

Example 3 includes the subject matter of any of Examples 1 and 2, wherein, for ones of the plurality of tasks, the deadline of the task is a normalized deadline calculated based on a number of working days in a predetermined time period, a deadline date of the task, and a current date.

Example 4 includes the subject matter of any of Examples 1 through 3, wherein, for ones of the plurality of tasks, the importance of the task is a normalized importance calculated based on an actual importance of the task and a highest importance of the plurality of tasks.

Example 5 includes the subject matter of any of Examples 1 through 4, further including determining, by the first computing device, a first task of the plurality of tasks being dependent on a task associated with another user, wherein sorting the plurality of tasks includes placing the first task at the end of the plurality of tasks based on the determination that the first task is dependent the task associated with the another user.

Example 6 includes the subject matter of any of Examples 1 through 5, further including grouping, by the first computing device, a second task and a third task of the plurality of tasks in a task block, the second task being dependent on the third task, wherein sorting the plurality of tasks includes placing the task block in the sorted plurality of tasks in accordance with an average of the priorities of the second task and the third task.

Example 7 includes the subject matter of Example 6, wherein sorting the plurality of tasks includes placing the task block in the sorted plurality of tasks in accordance with a number of tasks included in the task block.

Example 8 includes the subject matter of Example 6, further including sorting, by the first computing device, the second task and the third task within the task block based on dependency of the second task and the third task.

Example 9 includes a system including a processor and a non-volatile memory storing computer program code that when executed on the processor causes the processor to execute a process operable to: determine a plurality of tasks associated with a user; determine a priority of each task of the plurality of tasks based on a deadline and an importance of the task; determine dependencies between different ones of the plurality of tasks; sort the plurality of tasks based on the priority of each task of the plurality of tasks and the determined dependencies; and cause at least a portion of the sorted plurality of tasks to be displayed in a user interface (UI) of an application on another computing device.

Example 10 includes the subject matter of Example 9, wherein to determine the priority of a task includes to calculate a weighted sum of the deadline and the importance of the task.

Example 11 includes the subject matter of any of Examples 9 and 10, wherein, for ones of the plurality of tasks, the deadline of the task is a normalized deadline calculated based on a number of working days in a predetermined time period, a deadline date of the task, and a current date.

Example 12 includes the subject matter of any of Examples 9 through 11, wherein, for ones of the plurality of tasks, the importance of the task is a normalized importance calculated based on an actual importance of the task and a highest importance of the plurality of tasks.

Example 13 includes the subject matter of any of Examples 9 through 12, wherein the process is further operable to determine a first task of the plurality of tasks being dependent on a task associated with another user, and wherein to sort the plurality of tasks includes to place the first task at the end of the plurality of tasks based on the determination that the first task is dependent the task associated with the another user.

Example 14 includes the subject matter of any of Examples 9 through 13, wherein the process is further operable to group a second task and a third task of the plurality of tasks in a task block, the second task being dependent on the third task, and wherein to sort the plurality of tasks includes to place the task block in the sorted plurality of tasks in accordance with an average of the priorities of the second task and the third task.

Example 15 includes the subject matter of Example 14, wherein to sort the plurality of tasks includes to place the task block in the sorted plurality of tasks in accordance with a number of tasks included in the task block.

Example 16 includes the subject matter of Example 14, wherein the process is further operable to sort the second task and the third task within the task block based on dependency of the second task and the third task.

Example 17 includes a non-transitory machine-readable medium encoding instructions that when executed by one or more processors cause a process to be carried out. The process includes: determining a plurality of tasks associated with a user; determining a priority of each task of the plurality of tasks based on a deadline and an importance of the task; determining dependencies between different ones of the plurality of tasks; sorting the plurality of tasks based on the priority of each task of the plurality of tasks and the determined dependencies; and causing at least a portion of the sorted plurality of tasks to be displayed in a user interface (UI) of an application on another computing device.

Example 18 includes the subject matter of Example 17, wherein determining the priority of a task includes calculating a weighted sum of the deadline and the importance of the task.

Example 19 includes the subject matter of any of Examples 17 and 18, wherein, for ones of the plurality of tasks, the deadline of the task is a normalized deadline calculated based on a number of working days in a predetermined time period, a deadline date of the task, and a current date.

Example 20 includes the subject matter of any of Examples 17 through 19, wherein, for ones of the plurality of tasks, the importance of the task is a normalized importance calculated based on an actual importance of the task and a highest importance of the plurality of tasks.

Example 21 includes the subject matter of any of Examples 17 through 20, wherein the process further includes determining a first task of the plurality of tasks being dependent on a task associated with another user, wherein sorting the plurality of tasks includes placing the first task at the end of the plurality of tasks based on the determination that the first task is dependent the task associated with the another user.

Example 22 includes the subject matter of any of Examples 17 through 21, wherein the process further includes grouping a second task and a third task of the plurality of tasks in a task block, the second task being dependent on the third task, wherein sorting the plurality of tasks includes placing the task block in the sorted plurality of tasks in accordance with an average of the priorities of the second task and the third task.

Example 23 includes the subject matter of Example 22, wherein sorting the plurality of tasks includes placing the task block in the sorted plurality of tasks in accordance with a number of tasks included in the task block.

Example 24 includes the subject matter of Example 22, wherein the process further includes sorting the second task and the third task within the task block based on dependency of the second task and the third task.

As will be further appreciated in light of this disclosure, with respect to the processes and methods disclosed herein, the functions performed in the processes and methods may be implemented in differing order. Additionally or alternatively, two or more operations may be performed at the same time or otherwise in an overlapping contemporaneous fashion. Furthermore, the outlined actions and operations are only provided as examples, and some of the actions and operations may be optional, combined into fewer actions and operations, or expanded into additional actions and operations without detracting from the essence of the disclosed embodiments.

In the description of the various embodiments, reference is made to the accompanying drawings identified above and which form a part hereof, and in which is shown by way of illustration various embodiments in which aspects of the concepts described herein may be practiced. It is to be understood that other embodiments may be utilized, and structural and functional modifications may be made without departing from the scope of the concepts described herein. It should thus be understood that various aspects of the concepts described herein may be implemented in embodiments other than those specifically described herein. It should also be appreciated that the concepts described herein are capable of being practiced or being carried out in ways which are different than those specifically described herein.

As used in the present disclosure, the terms “engine” or “module” or “component” may refer to specific hardware implementations configured to perform the actions of the engine or module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations, firmware implements, or any combination thereof are also possible and contemplated. In this description, a “computing entity” may be any computing system as previously described in the present disclosure, or any module or combination of modulates executing on a computing system.

Terms used in the present disclosure and in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, such recitation should be interpreted to mean at least the recited number (e.g., the bare recitation of “two widgets,” without other modifiers, means at least two widgets, or two or more widgets). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “connected,” “coupled,” and similar terms, is meant to include both direct and indirect, connecting, and coupling.

All examples and conditional language recited in the present disclosure are intended for pedagogical examples to aid the reader in understanding the present disclosure, and are to be construed as being without limitation to such specifically recited examples and conditions. Although example embodiments of the present disclosure have been described in detail, various changes, substitutions, and alterations could be made hereto without departing from the spirit and scope of the present disclosure. Accordingly, it is intended that the scope of the present disclosure be limited not by this detailed description, but rather by the claims appended hereto.

What is claimed is:

1. A method comprising:
determining, by a first computing device, a plurality of tasks associated with a user;
determining, by the first computing device, a priority of each task of the plurality of tasks based on a deadline and an importance of the task;
determining, by the first computing device, dependencies between different ones of the plurality of tasks;
sorting, by the first computing device, the plurality of tasks based on the priority of each task of the plurality of tasks and the determined dependencies; and
causing, by the first computing device, at least a portion of the sorted plurality of tasks to be displayed in a user interface (UI) of an application on a second computing device.

2. The method of claim 1, wherein determining the priority of a task includes calculating a weighted sum of the deadline and the importance of the task.

3. The method of claim 1, wherein, for ones of the plurality of tasks, the deadline of the task is a normalized deadline calculated based on a number of working days in a predetermined time period, a deadline date of the task, and a current date.

4. The method of claim 1, wherein, for ones of the plurality of tasks, the importance of the task is a normalized importance calculated based on an actual importance of the task and a highest importance of the plurality of tasks.

5. The method of claim 1, further comprising:
determining, by the first computing device, a first task of the plurality of tasks being dependent on a task associated with another user, wherein sorting the plurality of tasks includes placing the first task at the end of the plurality of tasks based on the determination that the first task is dependent the task associated with the another user.

6. The method of claim 1, further comprising:
grouping, by the first computing device, a second task and a third task of the plurality of tasks in a task block, the second task being dependent on the third task, wherein sorting the plurality of tasks includes placing the task block in the sorted plurality of tasks in accordance with an average of the priorities of the second task and the third task.

7. The method of claim 6, wherein sorting the plurality of tasks includes placing the task block in the sorted plurality of tasks in accordance with a number of tasks included in the task block.

8. The method of claim 6, further comprising sorting, by the first computing device, the second task and the third task within the task block based on dependency of the second task and the third task.

9. A system comprising:
a processor; and
a non-volatile memory storing computer program code that when executed on the processor causes the processor to execute a process operable to:
determine a plurality of tasks associated with a user;
determine a priority of each task of the plurality of tasks based on a deadline and an importance of the task;
determine dependencies between different ones of the plurality of tasks;
sort the plurality of tasks based on the priority of each task of the plurality of tasks and the determined dependencies; and
cause at least a portion of the sorted plurality of tasks to be displayed in a user interface (UI) of an application on another computing device.

10. The system of claim 9, wherein to determine the priority of a task includes to calculate a weighted sum of the deadline and the importance of the task.

11. The system of claim 9, wherein, for ones of the plurality of tasks, the deadline of the task is a normalized deadline calculated based on a number of working days in a predetermined time period, a deadline date of the task, and a current date.

12. The system of claim 9, wherein, for ones of the plurality of tasks, the importance of the task is a normalized importance calculated based on an actual importance of the task and a highest importance of the plurality of tasks.

13. The system of claim 9, wherein the process is further operable to determine a first task of the plurality of tasks being dependent on a task associated with another user, and wherein to sort the plurality of tasks includes to place the first task at the end of the plurality of tasks based on the determination that the first task is dependent the task associated with the another user.

14. The system of claim 9, wherein the process is further operable to group a second task and a third task of the plurality of tasks in a task block, the second task being dependent on the third task, and wherein to sort the plurality of tasks includes to place the task block in the sorted plurality of tasks in accordance with an average of the priorities of the second task and the third task.

15. The system of claim 14, wherein to sort the plurality of tasks includes to place the task block in the sorted plurality of tasks in accordance with a number of tasks included in the task block.

16. The system of claim 14, wherein the process is further operable to sort the second task and the third task within the task block based on dependency of the second task and the third task.

17. A non-transitory machine-readable medium encoding instructions that when executed by one or more processors cause a process to be carried out, the process including:
determining a plurality of tasks associated with a user;
determining a priority of each task of the plurality of tasks based on a deadline and an importance of the task;
determining dependencies between different ones of the plurality of tasks;
sorting the plurality of tasks based on the priority of each task of the plurality of tasks and the determined dependencies; and
causing at least a portion of the sorted plurality of tasks to be displayed in a user interface (UI) of an application on another computing device.

18. The machine-readable medium of claim 17, wherein determining the priority of a task includes calculating a weighted sum of the deadline and the importance of the task.

19. The machine-readable medium of claim 17, wherein, for ones of the plurality of tasks, the deadline of the task is a normalized deadline calculated based on a number of working days in a predetermined time period, a deadline date of the task, and a current date.

20. The machine-readable medium of claim 17, wherein, for ones of the plurality of tasks, the importance of the task is a normalized importance calculated based on an actual importance of the task and a highest importance of the plurality of tasks.
